(19) United States
(12) Patent Application Publication
(10) Pub. No.: US 2003/0026595 A1
(43) Pub. Date: Feb. 6, 2003

(54) Handy karaoke equipment

(76) Inventor: Tetsuya Ikeda, Tokyo (JP)

Correspondence Address: Joseph W. Price, PRICE AND GESS, 2100 S.E. Main St., Ste. 250, Irvine, CA, 92614, US

(21) Appl. No.: 09/922,979

(22) Filed: Aug. 6, 2001

(51) Int. Cl. H04N 5/91

(52) U.S. Cl. 386/96

(57) ABSTRACT

A handy karaoke equipment capable of being readily connected to a desired external equipment such as a TV, permitting users to enjoy it in a sense of a game like a TV game, and being manufactured at a reduced cost. An equipment body which has a microphone integrally incorporated therein is detachably mounted therein with a data cartridge having image data and performed music data stored therein. An operation section is arranged for selecting performed music and setting conditions for performance of the music selected such as a tempo of the music, a key thereof, an echo and the like. Also, the equipment body is provided therein with an audio signal processing section for converting the performed music data read out of the data cartridge into a performance signal, combining the performance signal and a sound signal inputted thereto from the microphone with each other to prepare a combined signal and converting the combined signal into an audio signal depending on the performance conditions. Further, the equipment body is provided therein with a video signal processing section for converting the image data read out of the data cartridge into a video signal.

### BACKGROUND OF THE INVENTION

This invention relates to a handy karaoke equipment, and more particularly to a handy karaoke equipment including a data cartridge in which repertoires and words are stored and which is detachably mounted in a grip of a microphone and adapted to combine a voice inputted to the microphone and performed music with each other and output words to an external equipment such as a TV or the like.

The term “karaoke” is generally defined to be “a form of entertainment, offered typically bars or clubs, in which people take turns to sing popular songs into a microphone over pre-recording backing tracks” (The New Oxford Dictionary of English published by Oxford University Press in 1998).

Karaoke equipments which have been recently spread include a karaoke equipment of the stationary type and a down-sized one of the portable type. The down-sized karaoke equipment which is also referred to as a handy karaoke equipment is rendered handy to carry, to thereby exhibit an advantage capable of being conveniently used in any desired place such as the open air.

In order to use the handy karaoke equipment in such a manner, it is required to carry an equipment body, as well as a record medium in which repertories are recorded such as a cassette tape, a compact disc or the like. In order to solve the problem, techniques of storing repertories in a memory of the equipment body are proposed. Unfortunately, this causes the number of repertories stored to be subjected to restriction, to thereby fail to additionally store new repertories and user s favorite repertories therein.

### SUMMARY OF THE INVENTION

The present invention has been made in view of the foregoing disadvantage of the prior art.

Accordingly, it is an object of the present invention to provide a handy karaoke equipment which is capable of being readily connected to a desired external equipment such as a TV or the like.

It is another object of the present invention to provide a handy karaoke equipment which is capable of permitting users to enjoy it in a sense of a game such as a TV game.

It is a further object of the present invention to provide a handy karaoke equipment which is capable of being manufactured at a reduced cost.

In accordance with the present invention, a handy karaoke equipment is provided. The handy karaoke equipment includes an equipment body formed in imitation of a hand microphone which includes a grip portion of a thickness sufficient to permit a user to grip it by one hand and including a head portion which has a microphone integrally incorporated therein, as well as a data cartridge detachably mounted in the equipment body and having image data and data on music performed (performed music data) stored therein. The equipment body includes an operation section for selecting music to be performed (performed music) and setting conditions for performance (performance conditions) of the music selected. The equipment body is provided therein with an audio signal processing section. The audio signal processing section functions to convert the performed music data read out of the data cartridge into a performance signal, combine the performance signal and a sound signal inputted thereto from the microphone with each other to prepare a combined signal, and convert the combined signal into an audio signal depending on the performance conditions. The equipment body is provided therein with a video signal processing section for converting the image data read out of the data cartridge into a video signal.

In a preferred embodiment of the present invention, the audio signal and video signal may be outputted to an external equipment by cable. Alternatively, only the audio signal is outputted to an external equipment by radio.

In a preferred embodiment of the present invention, the equipment body is provided on a front surface thereof with a display for displaying the operation section and operation by the operation section. The equipment body is provided on a rear surface thereof with a connector in which the data cartridge is inserted.

### BRIEF DESCRIPTION OF THE DRAWINGS

These and other objects and many of the attendant advantages of the present invention will be readily appreciated as the same becomes better understood by reference to the following detailed description when considered in connection with the accompanying drawings; wherein:

FIG. 1 is a perspective view showing a karaoke system in which an embodiment of a handy karaoke equipment according to the present invention is incorporated;

FIG. 2A is a fragmentary front elevation view showing an essential part of an equipment body of the handy karaoke equipment shown in FIG. 1;

FIG. 2B is a fragmentary rear view of the essential part of the equipment body shown in FIG. 2A;

FIG. 3 is a diagrammatic view showing an electrical circuit incorporated in the handy karaoke equipment of FIG. 1;

FIGS. 4A, 4B and 4C each are a schematic view showing an image displayed in the progress of karaoke performance; and

FIG. 5 is a perspective view showing another manner of operation of the handy karaoke equipment of FIG. 1.

### DETAILED DESCRIPTION OF THE PREFERRED EMBODIMENT

Now, a handy karaoke equipment according to the present invention will be described with reference to the accompanying drawings.

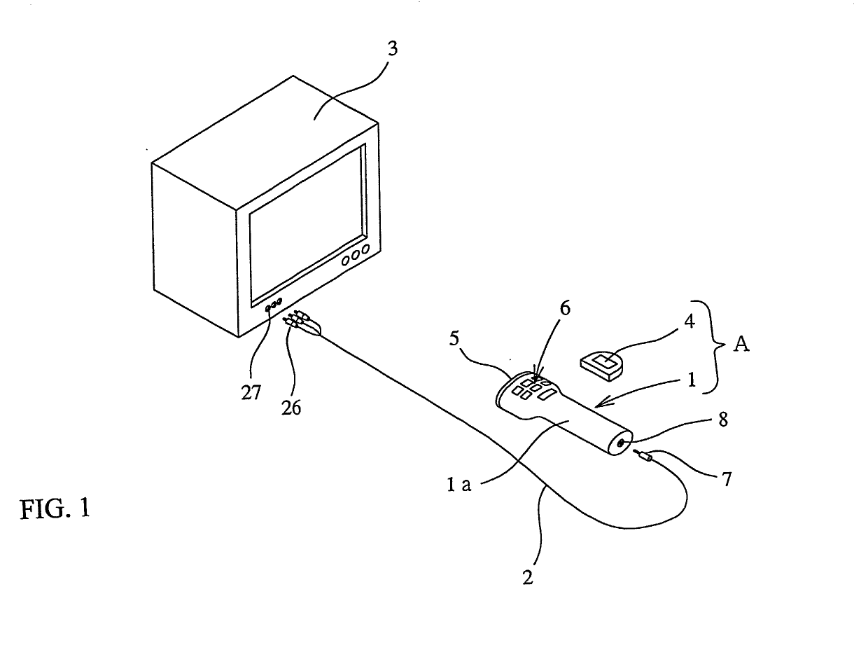

Referring first to FIG. 1, a karaoke system in which an embodiment of a handy karaoke equipment according to the present invention is incorporated is illustrated. The karaoke system generally includes a handy karaoke equipment A of the present invention and a TV acting as an external equipment 3 connected to the handy karaoke equipment A through an audio/video cable (hereinafter referred to “AV cable”) 2. The handy karaoke equipment A of the illustrated embodiment generally includes an equipment body 1 and a data cartridge 4 detachably mounted in the equipment body 1.

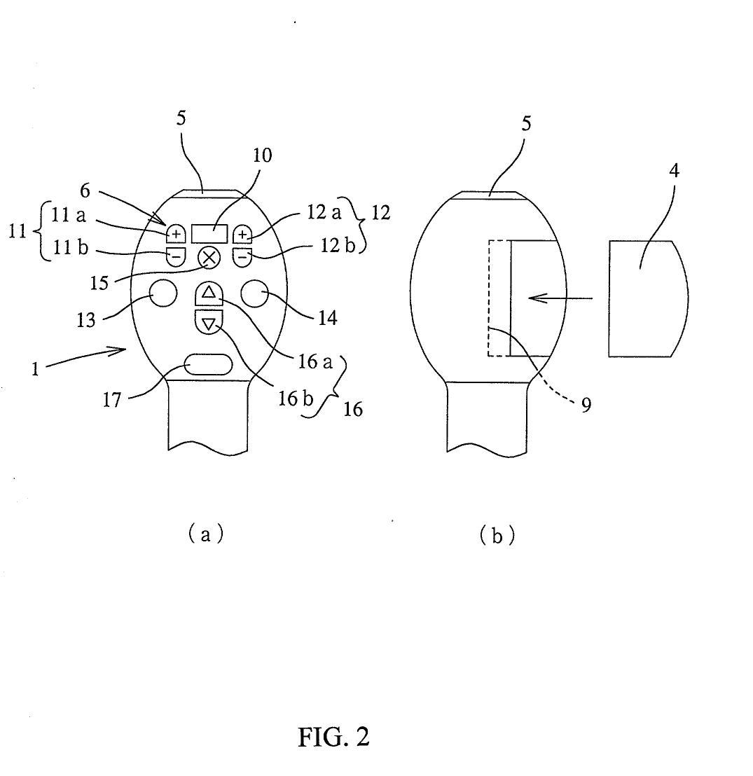

The equipment body 1 is configured in imitation of a hand microphone and includes a grip portion 1a of a thickness sufficient to permit a user to grip it by one hand. The equipment 1 has a head portion which has a microphone 5 integrally incorporated therein, through which a voice of a user or performer is inputted to the equipment body 1 of the handy karaoke equipment. The equipment body 1 is provided on an upper portion of a front surface thereof with an operation section 6 including a variety of operation buttons. Also, the equipment body 1 is provided on a lower end thereof with a socket 8 in which a plug 7 of the AV cable 2 is inserted. Further, the equipment body 1 is provided on a rear surface thereof with a connector 9 in which the data cartridge 4 is fitted, as shown in FIG. 2B.

The operation section 6, as shown in FIG. 2A, includes a display 10, tempo control buttons 11 (11a, 11b) for controlling a reproducing speed or tempo of music being performed depending on user s choice, volume control buttons 12 (12a, 12b) for controlling a volume of a reproduced sound of the music being performed, an echo setting button 13 for setting a reverberation or echo effect at a desired level, an effect selection button 14 for varying a frequency of an output voice with respect to a frequency of a voice inputted from the microphone 5 thereto to change the input voice into a male voice, a female voice or the like, a cancel button 15 for canceling various kinds of setting, selection/key buttons 16 (16a, 16b) used for selection operation, a decision button 17 for rendering results selected by the selection/key button 16 effective, and the like.

The display 10 is constituted by light emitting diodes for two digits each constituted by seven (7) segments. The display 10 functions to display a music number thereon when the selection/key button 16 is pushed, so that a user may confirm performed music by means of a music numeral indicated on the display 10.

The tempo control buttons 11 (11a, 11b) function to vary a tempo of performed music. More particularly, the tempo control buttons 11 are so constructed that pushing of the tempo control button 11a leads to an increase in tempo and that of the tempo control button 11b leads to a reduction in tempo.

The volume control buttons 12 (12a, 12b) function to adjust a sound volume. More particularly, the volume control buttons 12 are so constructed that pushing of the volume control button 12a leads to an increase in sound volume and that of the volume control button 12b leads to a reduction in sound volume.

The echo selection button 13 functions to select an reverberation or echo effect such as reverberation in a bathroom, that in a hall, an echo effect or the like.

The effect selection button 14 functions to change a voice inputted to the equipment body 1 into a male voice, a female voice, a voice full of grace notes such as a voice for a popular ballad song, or the like depending on user s choice.

The selection/key buttons 16 (16a, 16b) are constructed so as to carry out both a function of selecting performed music and a key function of varying a key of the music to a level desired by a player, wherein the selection function has preference to the key function during display of a menu on an image plane of the display 10 and the key function has preference to the selection function during performance of music. When the selection/key button 16a is pushed during the menu display, the next music may be selected. Whereas, pushing of the selection/key button 16b during the menu display permits selection of the previous music. Also, when the selection/key button 16a is pushed during performance of music, a key is ascended, whereas pushing of the selection/key button 16b during the performance leads to descent of a key.

The decision button 17 functions to decide details or items selected by a performer every time when it is pushed after selection of performed music or after setting of various parameters.

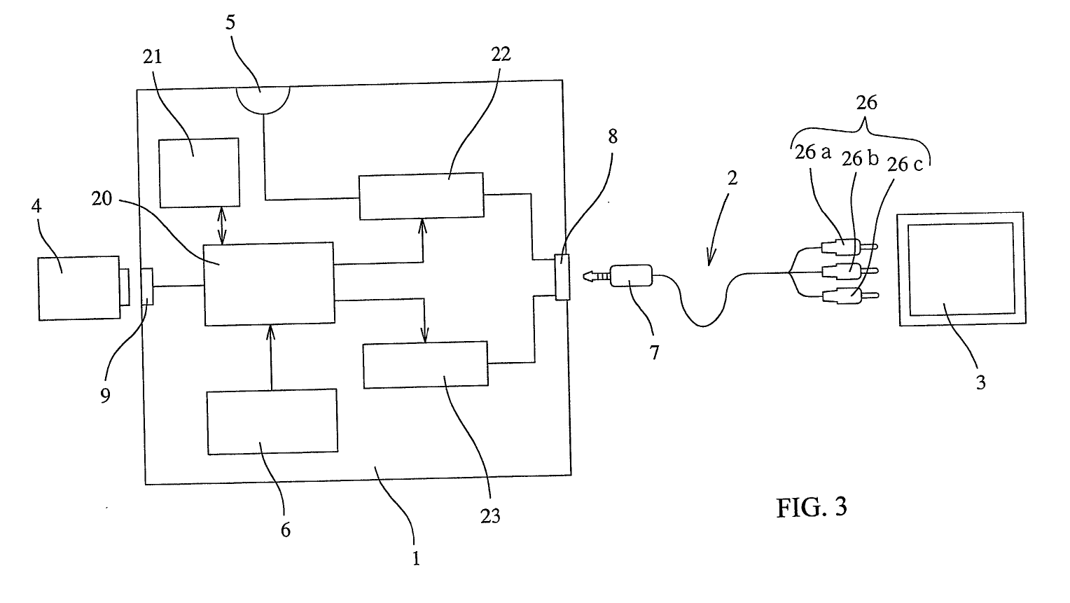

Now, an electric structure incorporated in the handy karaoke equipment of the illustrated embodiment will be described with reference to FIG. 3. In FIG. 3, reference numeral 20 designates a control section, which functions to control an audio signal processing section 22 and a video signal processing section 23 depending on an operation signal inputted from the operation section 6 and a control program stored in a memory 21. For this purpose, the control section 20 is constructed so as to read data out of the data cartridge 4 inserted in the connector 9 of the equipment body 1, and output a play or performance signal for performing music selected to the audio signal processing section 22 and an image signal for displaying a title of the music, words thereof, a background thereof and the like to the video signal processing section 23.

The audio signal processing section 22 is configured so as to subject a sound signal inputted thereto from the microphone 5 and a performance signal outputted from the control section 20 to both mixing and amplification. Also, the audio signal processing section 22 functions to add effects such as an echo, a level of a key, a speed of performed music, a voice change and the like to a signal obtained by the mixing and then output the signal in the form of an audio signal to the TV 3 through the AV cable 2. The video signal processing section 23 functions to output a video signal containing image information for displaying a title of the music, words thereof and the like inputted thereto from the data cartridge 4 to the TV 3 through the AV cable 2.

The video signal and audio signal thus outputted are inputted to an AV input terminal 25 of the TV 3. The video signal inputted is displayed in the form of an image indicating words of the music, a background thereof and the like on a monitor of the TV. The audio signal is outputted in the form of performed music and a sound from a speaker of the TV 3.

The data cartridge 4 has a read only memory (ROM) incorporated therein, which has data on performed music, words thereof and background pictures thereof stored therein. The data cartridge 4 is inserted or fitted in the connector 9 of the equipment body 1, to thereby permit data stored therein to be read out thereof.

Now, the manner of operation of the handy karaoke equipment of the illustrated embodiment thus constructed will be described.

First, the data cartridge 4 is inserted in the connector 9 of the equipment body 1 and the plug 7 of the AV cable 2 is fitted in the socket 8 of the equipment body 1. Also, plugs 26 (26a, 26b and 26c) are inserted in AV input terminals 27 of the TV 3, followed by turning-on of a power supply.

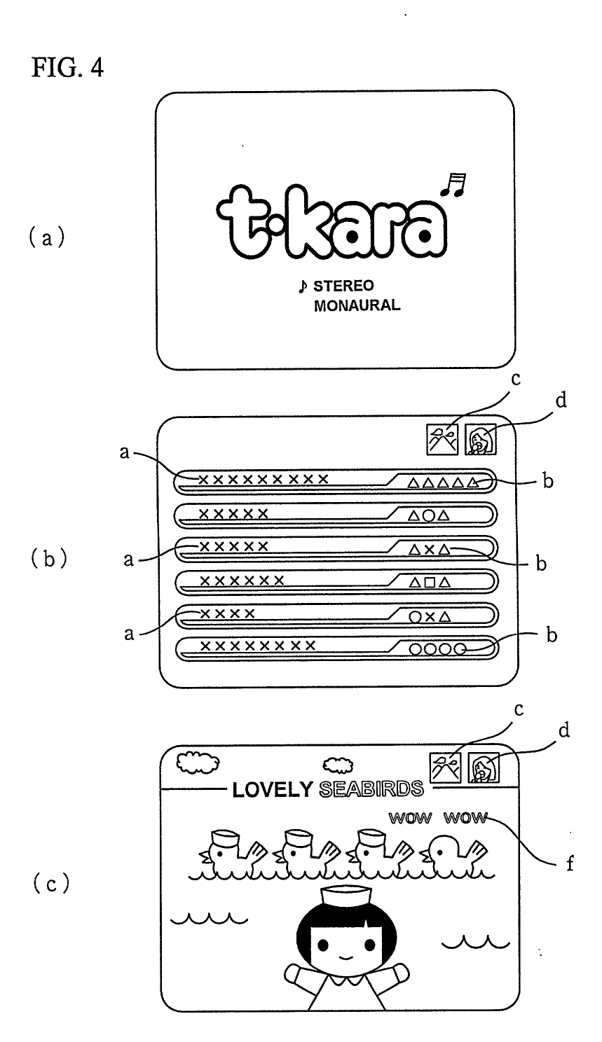

Such turning-on of the power supply permits a title image (FIG. 4(a)) to be displayed on the monitor of the TV 3. An indication “STEREO” or “MONAURAL” is selected by means of the selection/key buttons 16 and then the decision button 17 is pushed, resulting in a music selection image (FIG. 4(b)) being displayed thereon. The music selection image includes a music title a and a singer name b, as well as an echo set icon c and a voice change set icon d, so that pushing operation of the operation section 6 permits setting of an echo, voice change or the like to be selected depending on user s demand. Then, performed music is selected and the decision button 17 is operated or pushed, to thereby decide the music.

Then, the music selected is outputted from the speaker of the TV 3; therefore, when a user or performer sings a song of the music at the microphone 2, it detects the song. This results in the song being combined with the music which is being performed and then converted into an audio signal in the audio signal processing 22. Then, the sing is outputted together with the music being performed from the speaker.

At this time, words f of the music are displayed on the monitor of the TV 3 as shown in FIG. 4(c) and the display is varied with progress of performance of the music, so that the performer may sing the song while making reference to the words displayed on the monitor. Also, by selecting voice change, an echo and the like as desired, the performer may not only sing the song in conformity to the music being performed, but enjoy karaoke performance while adding a sense of play thereto.

In the illustrated embodiment, the external equipment 3 is constituted by a TV. Alternatively, it may be constituted by a radio equipment, so that a user or performer may enjoy karaoke performance using only a sound. In this instance, the AV cable 2 may be connected at only sound terminals 26a and 26b thereof to a radio equipment (not shown).

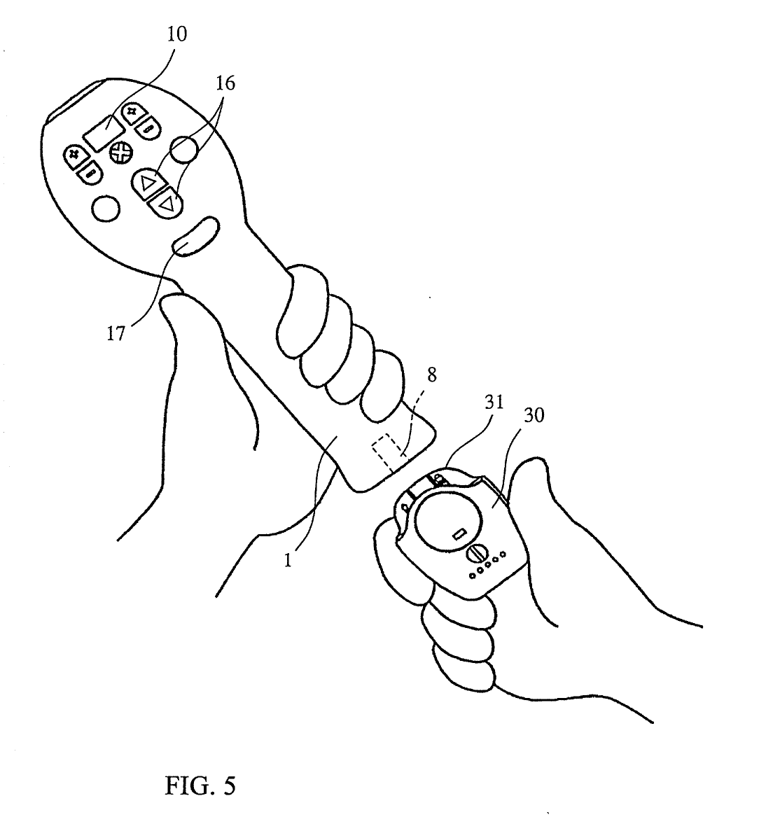

Alternatively, the illustrated embodiment may be constructed in such a manner as shown in FIG. 5. More particularly, a plug 31 of a wireless unit 30 is inserted in the socket 8 of the equipment body 1 to subject the audio signal to FM modulation, to thereby output it to the external equipment or radio unit (FM radio unit) by radio.

When the selection/key buttons 16 are pushed, a music number is indicated on the display 10. When a radio unit is used as the external equipment, the performer continues to operate the selection/key buttons 16 while looking at a wordbook attached to the data cartridge, to thereby indicate a music number desired on the display 10. Then, the decision button 17 is pushed, to thereby output music from the radio unit, so that the performer may sing a song of the music while looking at the wordbook.

As can be seen from the foregoing, the handy karaoke equipment of the present invention is so constructed that the equipment body is formed in imitation of a hand microphone and configured so as to exhibit all functions required for karaoke performance. This permits a user or performer to enjoy karaoke performance as if only a handy microphone is kept connected to the external equipment. Also, substitution of the data cartridge permits kinds of music performed and the number thereof to be increased unlimitedly, so that everyone may enjoy karaoke performance.

Also, in the present invention, the socket of the equipment body in which the data cartridge is fitted may be arranged on a rear side of the equipment body. This keeps the data cartridge from being observed from a front side of the equipment body and permits only the operation section and display to be arranged on the front side, resulting in aesthetic properties of the handy karaoke equipment being significantly enhanced and operability thereof being improved.

While a preferred embodiment of the present invention has been described with a certain degree of particularity with reference to the drawings, obvious modifications and variations are possible in light of the above teachings. It is therefore to be understood that within the scope of the appended claims, the invention may be practiced otherwise than as specifically described.

What is claimed is:

1. A handy karaoke equipment comprising:
an equipment body formed in imitation of a hand microphone which includes a grip portion of a thickness sufficient to permit a user to grip it by one hand and including a head portion which has a microphone integrally incorporated therein; and
a data cartridge detachably mounted in said equipment body and having image data and performed music data stored therein;
said equipment body including an operation section for selecting performed music and setting conditions for performance of the music selected;
said equipment body being provided therein with an audio signal processing section for converting the performed music data read out of said data cartridge into a performance signal, combining said performance signal and a sound signal inputted thereto from said microphone with each other to prepare a combined signal and converting the combined signal into an audio signal depending on the performance conditions;
said equipment body being provided therein with a video signal processing section for converting the image data read out of said data cartridge into a video signal.

2. A handy karaoke equipment as defined in claim 1, wherein said performance conditions include a tempo of the performed music selected, a key thereof and an echo.

3. A handy karaoke equipment as defined in claim 1, wherein said audio signal and video signal are outputted to an external equipment by cable.

4. A handy karaoke equipment as defined in claim 1, wherein only said audio signal is outputted to an external equipment by radio.

5. A handy karaoke equipment as defined in claim 1, wherein said equipment body is provided on a front surface thereof with a display for displaying said operation section and operation by said operation section; and
said equipment body is provided on a rear surface thereof with a connector in which said data cartridge is inserted.
